(19) United States
(12) Patent Application Publication
(10) Pub. No.: US 2007/0290050 A1
(43) Pub. Date: Dec. 20, 2007

(54) Memory card and memory card/adaptor combination

(76) Inventor: Chao-Chang Chen, Shulin City (TW)

Correspondence Address: PRO-TECHTOR INTERNATIONAL SERVICES, 20775 NORADA CT., SARATOGA, CA, 95070, US

(21) Appl. No.: 11/498,546

(22) Filed: Aug. 3, 2006

(30) Foreign Application Priority Data
Jun. 20, 2006 (TW) 95210686

(51) Int. Cl. G06K 19/06

(52) U.S. Cl. 235/492

(57) ABSTRACT

A memory card includes a first end and a second end. The first end of the memory card is sized to couple with a coupling opening of a USB socket. A USB interface and a read/write interface are provided on the first end of the memory card. The USB interface includes a plurality of first contacts. The read/write interface includes a plurality of second contacts that are aligned with the first contacts. The first contacts and the second contacts are alternately disposed. The memory card can be inserted into an adaptor so as to be converted into another memory card of another type.

### BACKGROUND OF THE INVENTION

1. Field of the Invention

The present invention relates to a memory card including an end with a universal serial bus (USB) interface and a read/write interface. The present invention also relates to a memory card/adaptor combination.

2. Description of the Related Art

Electronic cards are widely used in computers and electronic dictionaries for expanding memories, network cards, modems, and small computer system interfaces (SCSI) such as high-capacity hard disks, scanners, etc. In addition to personal computer memory card international association (PCMCIA) card, electronic cards includes multi-media cards (MMC), compact flash cards (CF), smart media cards (SMC), memory sticks (MS), secure digital memory cards (SD) for use in personal digital assistants (PDA), portable electronic dictionaries, digital cameras, etc.

However, most memory cards have an interface of a specific specification and thus cannot be used with the connection interface of widely used USB (universal serial bus) specification. FIG. 1 of the drawings illustrates a dual-interface memory card 90 including a USB interface 91 on an end thereof for coupling with a USB socket 93 of an electronic device 92. An SD interface 94 is provided on the other end of the memory card 90 for coupling with a card connector.

When coupling or detaching the dual-interface memory card 90 with or from the USB socket 93, the USB interface 91 or the SD interface 94 is gripped and thus comes in contact with the user's fingers. More specifically, the interface 91 or 94 is exposed and thus liable to be damaged. Further, the overall length and the overall width of the dual-interface memory card 90 are larger than those of the USB interface 91 such that most part of the dual-interface memory card 90 is exposed outside the USB socket 93 and thus occupies the space required for connection of other connection ports and even interferes with insertion of other cards. Further, the dual-interface memory card 90 is liable to be impacted and thus damaged, resulting in problems to the user.

### SUMMARY OF THE INVENTION

In accordance with an aspect of the present invention, a memory card comprises a first end and a second end. The first end of the memory card is sized to couple with a coupling opening of a USB socket. A USB interface and a read/write interface are provided on the first end of the memory card. The USB interface includes a plurality of first contacts. The read/write interface includes a plurality of second contacts that are aligned with the first contacts. The first contacts and the second contacts are alternately disposed.

In an example, the first contacts are arranged in a row and the second contacts are arranged in two rows.

Preferably, the first contacts of the USB interface include a power contact that acts as a power contact for the read/write interface.

Preferably, the first contacts of the USB interface include a grounding contact that acts as a grounding contact for the read/write interface.

In accordance with another aspect of the present invention, the memory card is inserted into an adaptor and thus converted into a memory card of another type.

Preferably, the adaptor includes a first end and a second end. An opening extends from the second end of the adaptor toward the first end of the adaptor, forming an insertion groove for receiving the memory card. A plurality of resilient conductive plates are provided on a rear end of the insertion groove for respective electrical connection with the contacts of the read/write interface of the memory card. A plurality of third contacts are provided on a bottom face of the first end of the adaptor and match contacts of a read/write interface of another memory card. The third contacts of the adaptor are respectively in electrical connection with the resilient conductive plates.

When the memory card is inserted into the insertion groove of the adaptor, the second contacts of the read/write interface of the memory card are electrically connected via the resilient conductive plates to the third contacts of the adaptor.

Preferably, an overall width of the resilient conductive plates is smaller than that of the third contacts of the adaptor. Each resilient conductive plate includes a first end with a protruding contact portion for contacting with an associated one of the second contacts of the read/write interface of the memory card. Each resilient conductive plate further includes a second end in electrical connection with an associated one of the third contacts of the adaptor.

Preferably, the power contact of the first contacts of the USB interface is electrically connected to the protruding contact portion of one of the resilient conductive plates.

Preferably, the grounding contact of the first contacts of the USB interface is electrically connected to the protruding contact portion of one of the resilient conductive plates.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an electronic device and a conventional dual-interface memory card.

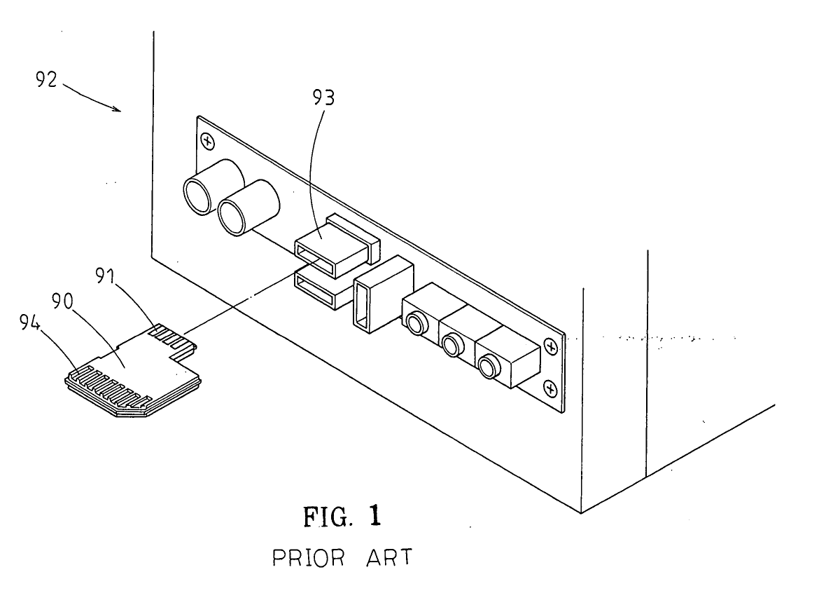

FIG. 2 is a top perspective view of a memory card in accordance with the present invention.

FIG. 3 is a bottom perspective view of the memory card in accordance with the present invention.

FIG. 4 is a bottom perspective view illustrating a modified example of the memory card in accordance with the present invention.

FIG. 5 is a perspective view illustrating use of the memory card in accordance with the present invention with an adaptor.

FIG. 6 is a perspective view of the adaptor in FIG. 5.

FIG. 7 is a bottom perspective view of the adaptor in FIG. 6.

FIG. 8 is a perspective view of the adaptor in FIG. 6, wherein a top cover is removed from the adaptor.

FIG. 9 is a perspective view illustrating use of the memory card in accordance with the present invention with another adaptor.

FIG. 10 is a bottom perspective view of the adaptor in FIG. 9.

### DETAILED DESCRIPTION OF THE PREFERRED EMBODIMENTS

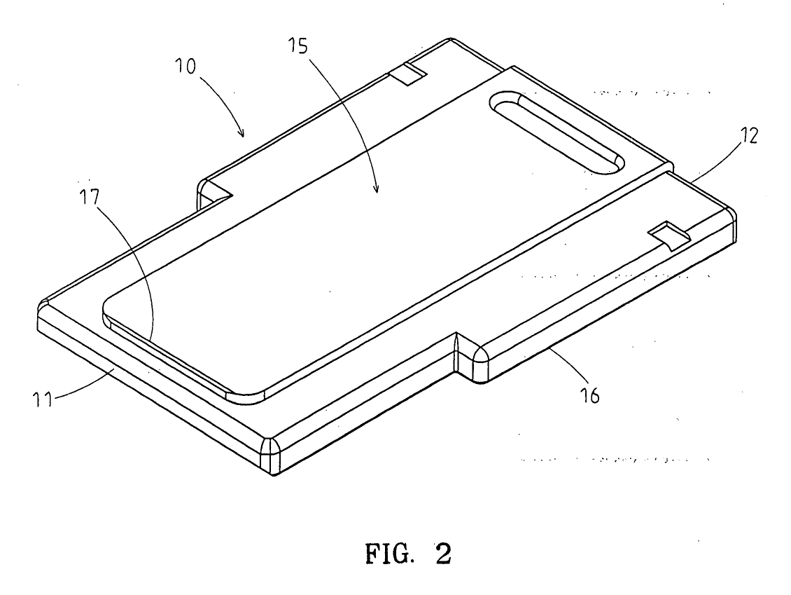

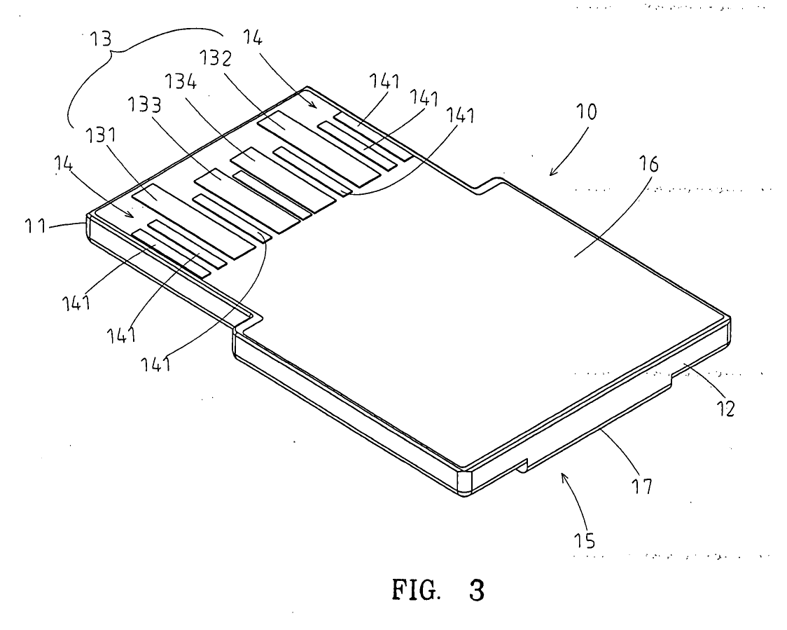

Referring to FIGS. 2 and 3, a memory card 10 in accordance with the present invention is substantially rectangular in section and comprises a plurality of memories and chips. The memory card 10 includes a first end 11 and a second end 12. The width of the first end 11 is identical to or approximately the same as that of the second end 12.

Referring to FIG. 3, the first end 11 of the memory card 10 includes a first, USB interface 13 and a second, read/write interface 14. Preferably, the USB interface 13 and the read/write interface 14 are mounted on a bottom face 16 of the memory card 10. The USB interface 13 may be coupled with a USB socket (not shown) of an electronic device (not shown). The width of the first end 11 of the memory card 10 is the same as that of a coupling opening (not shown) of the USB socket to allow insertion for access of information.

In this example, the USB interface 13 includes a plurality of spaced and aligned contacts, including a power contact 13 1, a grounding contact 132, and two data transmission contacts 133 and 134. The read/write interface 14 includes a plurality of spaced and aligned contacts 141. Preferably, the contacts 141 of the read/write interface 14 are aligned with the contacts 131-134 of the USB interface 13. More preferably, the contacts 141 of the read/write interface 14 and the contacts 131-134 of the USB interface 13 are alternately disposed and arranged in a row.

By such an arrangement, the memory card 10 may be coupled with a USB socket of an electronic device via the USB interface 13 or coupled with a read/write socket (not shown) of the same specification via the read/write interface 14.

When coupling or detaching the memory card 10 with or from the electronic device, a user grips the second end 12 of the memory card 10 and inserts the first end 11 of the memory card 10 into the USB socket of the electronic device. Although the second end 12 of the memory card 10 is exposed outside, the volume, length, and width of the exposed second end 12 are much smaller than those of conventional dual-interface memory cards. This avoids occupation of the space for other connection ports, allowing easy insertion of other memory cards and reducing the risk of damage due to external impact.

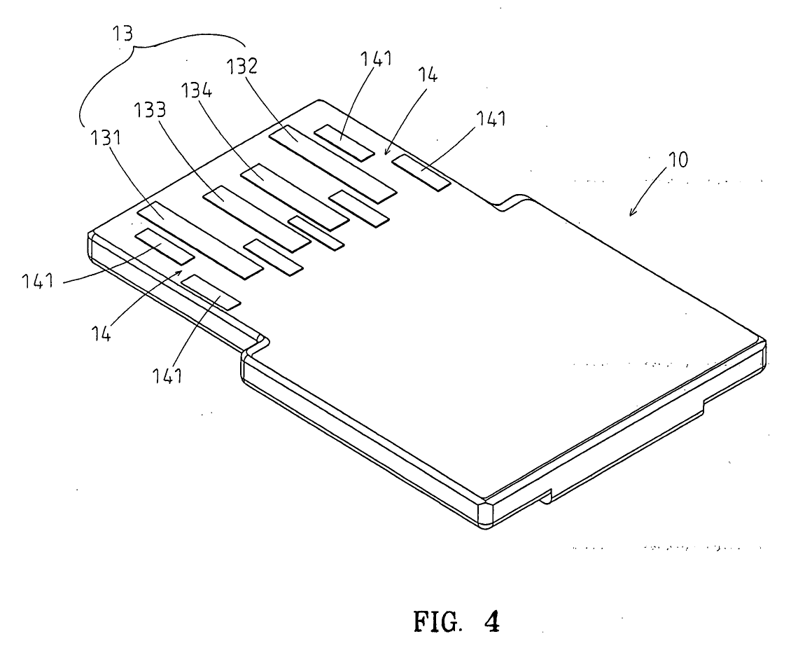

In a modified example shown in FIG. 4, the contacts 131-134 of the USB interface 13 are arranged in a row whereas the contacts 141 of the read/write interface 14 are arranged in two rows.

The read/write interface 14 and the USB interface 13 may share at least one contact. For example, the power contact 131 of the USB interface 13 may act as the power contact of the read/write interface 14 and/or the grounding contact 132 of the USB interface 13 may act as the grounding contact of the read/write interface 14. Thus, the first end 11 of the memory card 10 may use the contacts 141 of the read/write 14 and/or the power contact 131 and/or the grounding contact 132 for coupling with a read/write interface socket of the same specification.

In the example shown in FIG. 2, a bulge 17 is formed on a top face 15 of the memory card 10 and extends from the first end 11 through the second end 12, allowing the width and thickness of the first end 11 to match a corresponding socket.

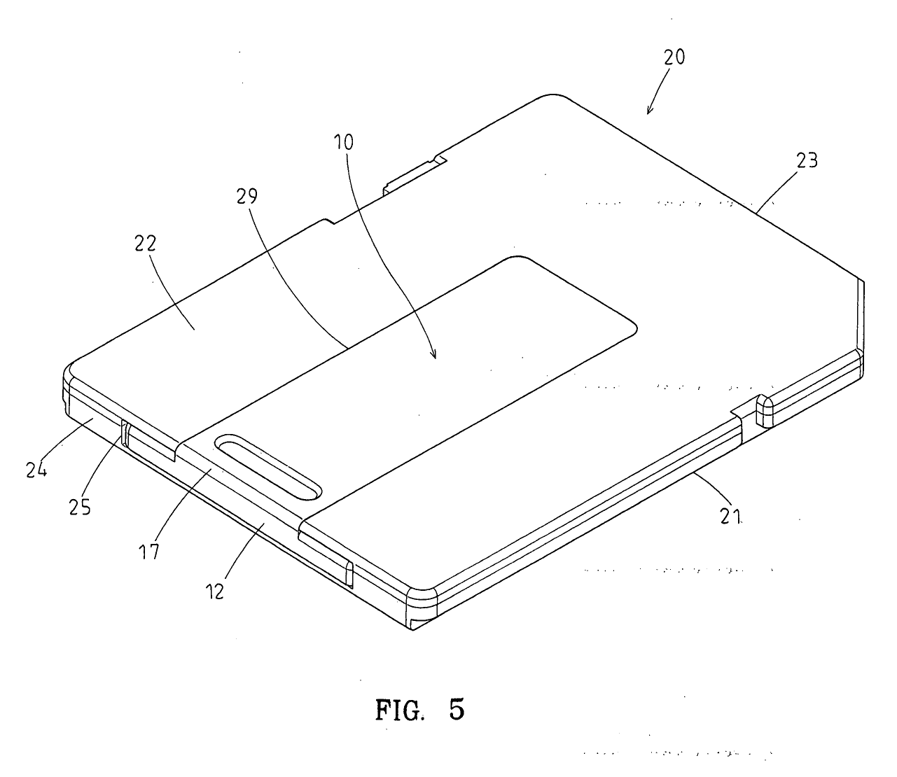

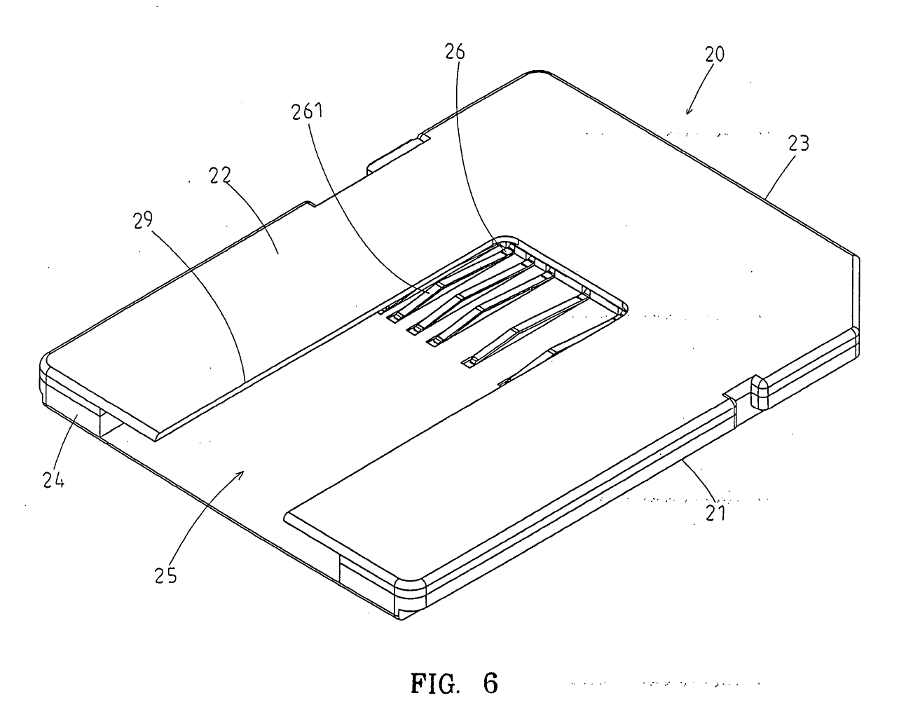

In another example shown in FIGS. 5 and 6, the memory card 10 is inserted into an adaptor 20 to provide a memory card of another type and of another interface specification for coupling with a currently available card connector of an ordinary electronic device.

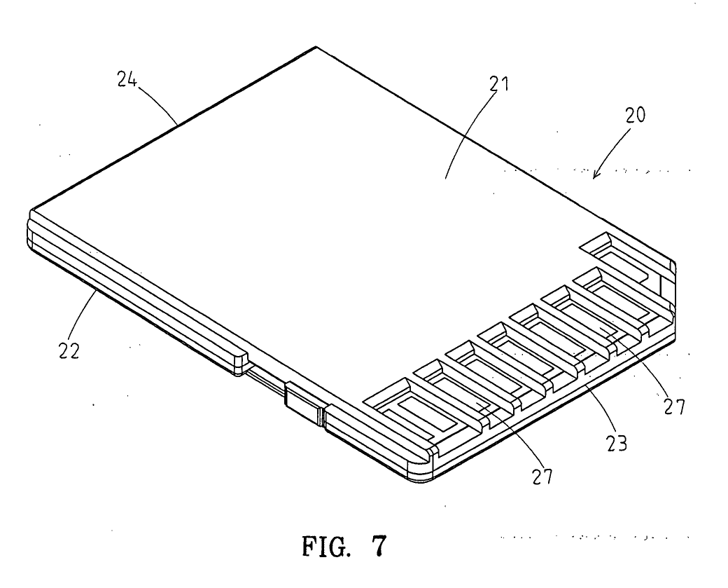

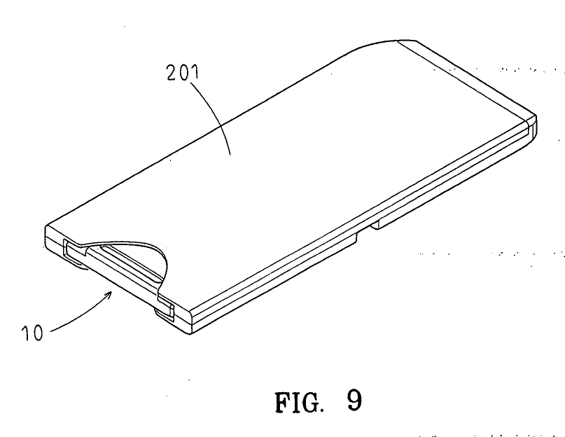

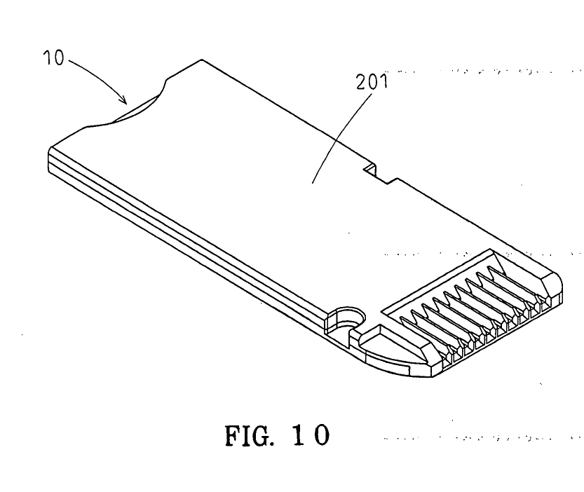

In the adaptor 20 shown in FIGS. 5 through 8, the specification (e.g., the length, width, and thickness) of the adaptor 20 is identical to that of another memory card. The adaptor 20 includes a first end 23 and a second end 24. An opening extends from an intermediate portion of the second end 24 toward the first end 23 of the adaptor 20 to form an insertion groove 25 for receiving the memory card 10. A plurality of resilient conductive plates 26 are provided in a rear end of the insertion groove 25 for respective electrical connection with the contacts 141 (see FIG. 3) of the read/write interface 14 of the memory card 10 and/or for electrical connection with the power contact 131 and/or the grounding contact 132 of the USB interface 13. Further, a plurality of contacts 27 (see FIG. 7) are provided on a bottom face of the first end 23 of the adaptor 20 and match those of the read/write interface of another memory card of the same specification. The contacts 27 are respectively and electrically connected to the resilient conductive plates 26 directly or via a circuit board 28. The adaptor 20 may be of SD memory card type of an ordinary memory card specification or of other memory card types. In another example shown in FIGS. 9 and 10, the memory card 10 is used with an MS adaptor 20 to form an MS type memory card.

When the memory card 10 is used with an adaptor 20, as illustrated in FIGS. 3 and 5-8, the first end 11 of the memory card 10 is inserted into the insertion groove 25 of the adaptor 20. The contacts 141 of the read/write interface 14 and/or the power contact 131 and/or the grounding contact 132 of the USB interface 13 of the memory card 10 are electrically connected to the contacts 27 via the resilient conductive plates 26 of the adaptor 20, allowing conversion into an interface of another memory card specification (such as the SD memory card in the figures) for coupling with an SD card connector of an ordinary electronic device.

Preferably, the adaptor 20 includes a plastic body 21 and a metal top cover 22 between which the insertion groove 25 is defined. Further, a guiding groove 29 is defined in an intermediate portion of the top cover 22 for guiding the bulge 17 of the memory card 10, allowing easy insertion/removal of the memory card 10.

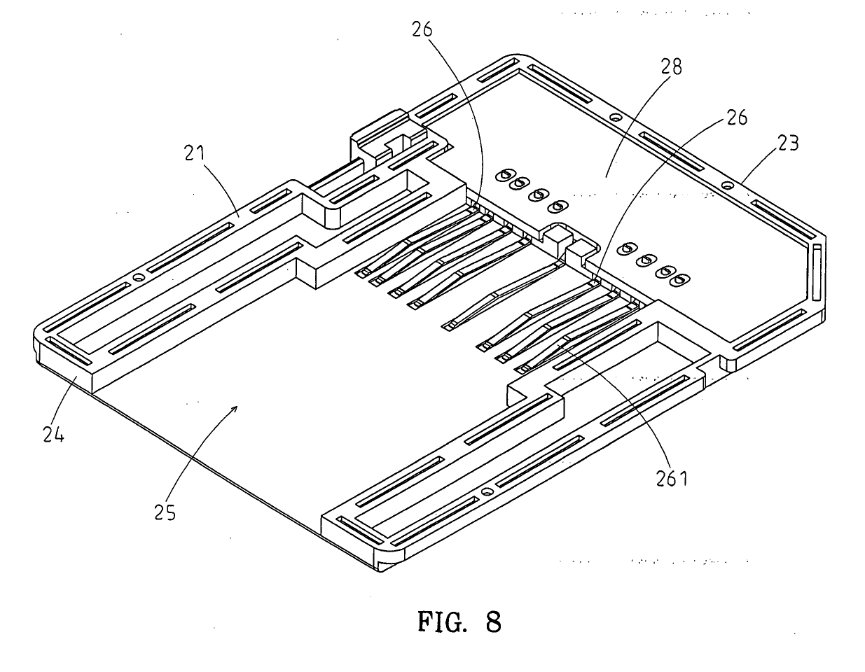

In the adaptor 20 shown in FIGS. 7 and 8, an overall width of the resilient conductive plates 26 is smaller than that of the contacts 27. Each resilient conductive plate 26 includes an end with a protruding contact portion 261 for contacting with an associated contact 141 (see FIG. 3) of the read/write interface 14 and/or the power contact 131 and/or the grounding contact 132 of the USB interface 13 of the memory card 10. Further, the other end of each resilient conductive plate 26 is in electrical connection with an associated contact 27 of the adaptor 20, allowing conversion into a memory card of another type with another interface specification.

Since the USB interface 13 and the read/write interface 14 are provided on the same end (the first end 11) of the memory card 10, these two interfaces 13 and 14 are not exposed when in use. Damage to these interfaces 13 and 14 by the user's fingers or external impact is avoided. The USB interface 13 of the memory card 10 can be selectively coupled with a USB socket. Alternatively, the read/write interface 14 of the memory card 10 can be selectively coupled with a read/write interface socket. Further, the memory card 10 can be inserted into an adaptor 20 to form a memory card (such as SD card, MS card, or other memory card) of another specification, allowing reading/writing of data. Multiple usages are provided.

Although specific embodiments have been illustrated and described, numerous modifications and variations are still possible without departing from the invention. The scope of the invention is limited by the accompanying claims.

What is claimed is:

1. A memory card comprising a first end and a second end, the first end of the memory card being sized to couple with a coupling opening of a USB socket, a USB interface and a read/write interface being provided on the first end of the memory card, the USB interface including a plurality of first contacts, the read/write interface including a plurality of second contacts that are aligned with the first contacts, the first contacts and the second contacts being alternately disposed.

2. The memory card as claimed in claim 1 wherein the first contacts are arranged in a row and the second contacts are arranged in two rows.

3. The memory card as claimed in claim 1 wherein the first contacts of the USB interface include a power contact that acts as a power contact for the read/write interface.

4. The memory card as claimed in claim 2 wherein the first contacts of the USB interface include a power contact that acts as a power contact for the read/write interface.

5. The memory card as claimed in claim 1 wherein the first contacts of the USB interface include a grounding contact that acts as a grounding contact for the read/write interface.

6. The memory card as claimed in claim 2 wherein the first contacts of the USB interface include a grounding contact that acts as a grounding contact for the read/write interface.

7. The memory card as claimed in claim 1 wherein the first contacts of the USB interface include a power contact that acts as a power contact for the read/write interface, and wherein the first contacts of the USB interface include a power contact that acts as a power contact for the read/write interface.

8. The memory card as claimed in claim 2 wherein the first contacts of the USB interface include a power contact that acts as a power contact for the read/write interface, and wherein the first contacts of the USB interface include a power contact that acts as a power contact for the read/write interface.

9. A combination comprising:
a memory card comprising a first end and a second end, the first end of the memory card being sized to couple with a coupling opening of a USB socket, a USB interface and a read/write interface being provided on the first end of the memory card, the USB interface including a plurality of first contacts, the read/write interface including a plurality of second contacts that are aligned with the first contacts, the first contacts and the second contacts being alternately disposed; and
an adaptor for removably receiving the memory card to convert the memory card into another memory card of another type.

10. The combination as claimed in claim 9 wherein the first contacts of the USB interface include a power contact that acts as a power contact for the read/write interface.

11. The combination as claimed in claim 9 wherein the first contacts of the USB interface include a grounding contact that acts as a grounding contact for the read/write interface.

12. The combination as claimed in claim 9 wherein the adaptor includes a first end and a second end, an opening extending from the second end of the adaptor toward the first end of the adaptor, forming an insertion groove for receiving the memory card, a plurality of resilient conductive plates being provided on a rear end of the insertion groove for respective electrical connection with the contacts of the read/write interface of the memory card, a plurality of third contacts being provided on a bottom face of the first end of the adaptor and matching contacts of a read/write interface of another memory card, the third contacts of the adaptor being respectively in electrical connection with the resilient conductive plates.

13. The combination as claimed in claim 12 wherein when the memory card is inserted into the insertion groove of the adaptor, the second contacts of the read/write interface of the memory card are electrically connected via the resilient conductive plates to the third contacts of the adaptor.

14. The combination as claimed in claim 13 wherein an overall width of the resilient conductive plates is smaller than that of the third contacts of the adaptor, each said resilient conductive plate including a first end with a protruding contact portion for contacting with an associated one of the second contacts of the read/write interface of the memory card, each said resilient conductive plate further including a second end in electrical connection with an associated one of the third contacts of the adaptor.

15. The combination as claimed in claim 10 wherein the first contacts of the USB interface include a grounding contact that acts as a grounding contact for the read/write interface.

16. The combination as claimed in claim 14 wherein the first contacts of the USB interface include a power contact electrically connected to the protruding contact portion of one of the resilient conductive plates.

17. The combination as claimed in claim 14 wherein the first contacts of the USB interface include a grounding contact electrically connected to the protruding contact portion of one of the resilient conductive plates.

18. The combination as claimed in claim 17 wherein the first contacts of the USB interface include a grounding contact electrically connected to the protruding contact portion of one of the resilient conductive plates.
